(19) United States
(12) Patent Application Publication
(10) Pub. No.: US 2020/0041024 A1
(43) Pub. Date: Feb. 6, 2020

(54) VALVE DEVICE

(71) Applicant: FUJIKIN INCORPORATED, Osaka (JP)

(72) Inventors: Kazushi ITO, Osaka (JP); Jun KIMURA, Osaka (JP)

(73) Assignee: FUJIKIN INCORPORATED, Osaka (JP)

(21) Appl. No.: 16/498,700

(22) PCT Filed: Mar. 16, 2018
(86) PCT No.: PCT/JP2018/010438

§ 371 Date: Sep. 27, 2019

(30) Foreign Application Priority Data
Mar. 30, 2017 (JP) 2017-067463

(51) Int. Cl. F16K 31/06; F16K 7/12; F15B 1/04

(52) U.S. Cl. CPC F16K 31/0651; F16K 31/0668; F15B 1/04; F16K 7/12

(57) ABSTRACT

A valve device is provided that is capable of mounting of various electronic devices, and includes a gas-driven type power generation function to solve problems involving wiring or battery-replacement. The problem is solved by a valve device including a piston member that drives a diaphragm, an actuator part that receives supply of a driver gas and drives the piston member, a coil spring that presses the piston member, and a power generation unit that includes a coil provided to a movable part that moves in association with activation of the actuator part, and a permanent magnet provided to a fixed part that docs not move regardless of activation of the actuator part.

### FIELD OF THE INVENTION

The present invention relates to a valve device.

### DESCRIPTION OF THE BACKGROUND ART

In the field of valve devices as well, an electronic device such as a pressure sensor or a wireless communication module is mounted to increase the functionality of the device (refer to Patent Documents 1, 2, and 3). As means for supplying power used in these electronic devices, a method for driving various censors using a button battery is disclosed in Patent Document 2. Further, in Patent Document 3, a system is disclosed in which a controller transmits high frequency waves superimposed on a control input signal to an electromagnetic valve, and the valve extracts the high frequency component from the input control signal to obtain a power.

### PATENT DOCUMENTS

Patent Document 1: JP 2011-513832 A

Patent Document 2: JP 2016-513228 A

Patent Document 3: JP 2017-020530 A

### SUMMARY OF THE INVENTION

### Problems to be Solved in the Invention

Even with an air-driven type valve device using air pressure, that is used in a semiconductor manufacturing system, there is a demand to have a power source for operating the various electronic devices. As one means, it is conceivable to introduce a wiring for supplying a power from the outside to the valve device. However, in a fluid control system in which a large number of valves are installed, the wiring is not only complicated but requires careful design to attend explosion-proof problems. Additionally, as one means, a battery is used as a power source to solve problems involving wiring. However, this requires a primary battery with a capacity sufficient to meet the service life of the valve, or the task of regular battery replacement. Further, the high-frequency superimposed power transmission to the electromagnetic valve in Patent Document 3 cannot be applied to a valve that is an air-driven type.

An object of the present invention is to provide a valve device that is capable of mounting various electronic devices, and includes a power generation function to solve problems involving wiring or battery replacement.

### Means for Solving the Problems

A valve device according to the present invention comprises:

a movable part that receives a supply of a driver gas and drives a valve element,

a fixed part that docs not move regardless of activation of the movable part, and

a power generation unit including a coil coupled to one of the movable part and a driving part, and a permanent magnet coupled to the other of the movable part and the driving part.

Preferably, a configuration can be adopted in which the coil is provided to the movable part, and

the permanent magnet is provided to the fixed part.

Alternatively, a configuration can be adopted in which the valve device further includes a spring member that presses the movable part in one direction, and the power generation unit generates a power using a portion of energy stored in the spring member. In this case, a configuration can be adopted in which the valve device further includes a circuit for extracting only a current in a direction of power generated by the power generation unit when the driver gas supplied to the valve device is discharged outside.

### Effect of the Invention

According to the present invention, a power can be generated by a power generation unit while alleviating impact associated with an opening and closing operation of a valve element, making it possible to extend a service life of a valve device and enhance a functionality of the valve device.

### BRIEF DESCRIPTION OF THE DRAWINGS

FIG. 1 is an external perspective view of a valve device according to an embodiment of the present invention.

FIG. 2A is a longitudinal sectional view of the valve device in FIG. 1, in a closed state.

FIG. 2B is an enlarged sectional view of a region surrounded by a chain line A in FIG. 2A.

FIG. 3A is a longitudinal sectional view of the valve device in FIG. 1, in an opened state.

FIG. 3B is an enlarged sectional view of a region surrounded by a chain line B in FIG. 3A.

FIG. 4A is a schematic configuration diagram of a valve system including the valve device in FIG. 1.

FIG. 4B is a diagram for explaining a flow of energy during actuator-driving in the system in FIG. 4A.

FIG. 4C a diagram for explaining a flow of energy during pressure-release in the system in FIG. 4A.

FIG. 5A is a functional block diagram illustrating an example of a load circuit.

FIG. 5B is a functional block diagram illustrating another example of a load circuit.

### DESCRIPTION OF THE PREFERRED EMBODIMENTS

Embodiments of the present invention are described below with reference to the drawings. It should be noted that, in this specification and the drawings, components having substantially the same function are denoted using the same reference numeral, and duplicate descriptions thereof are omitted.

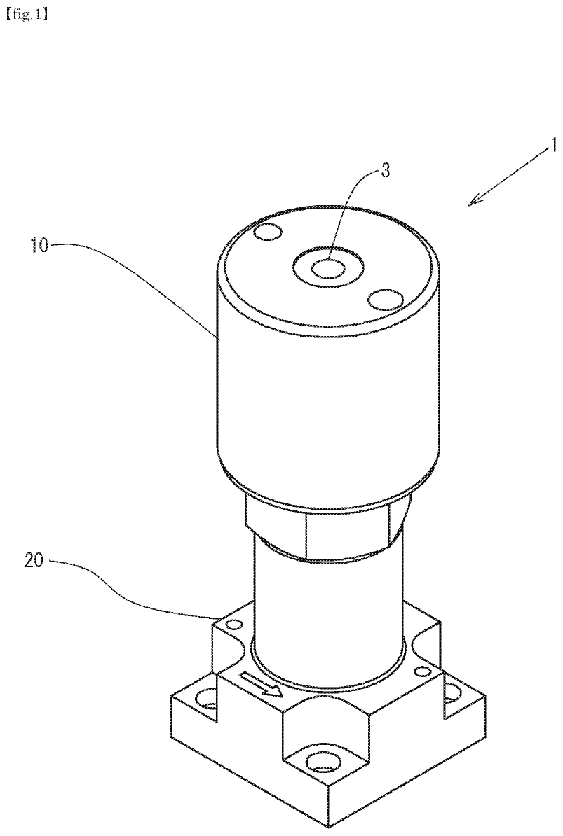

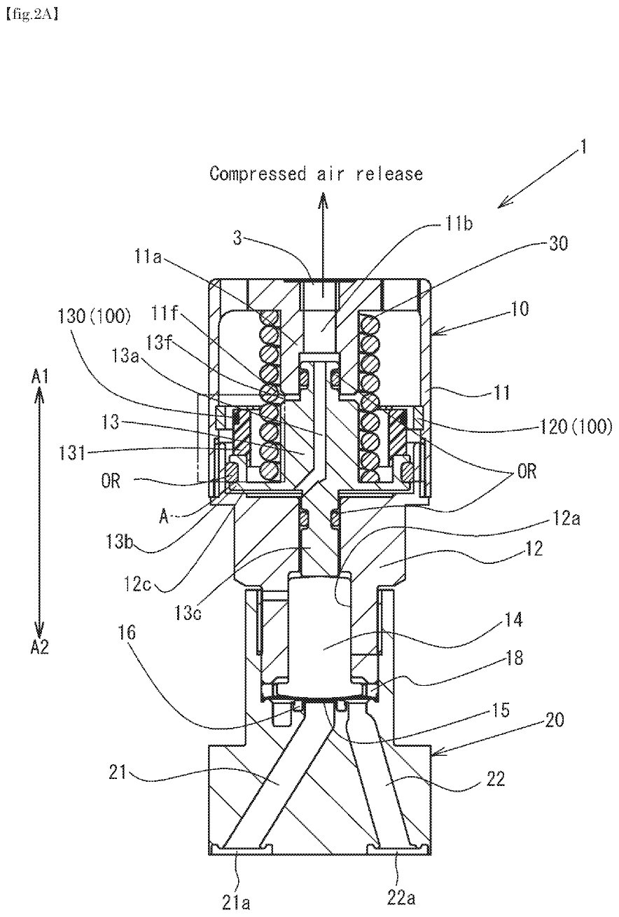

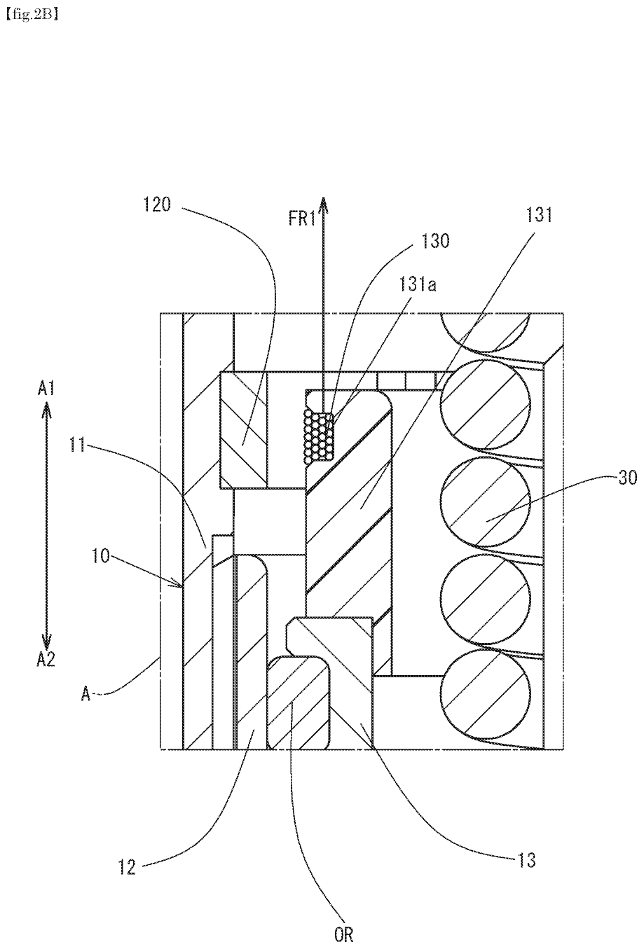

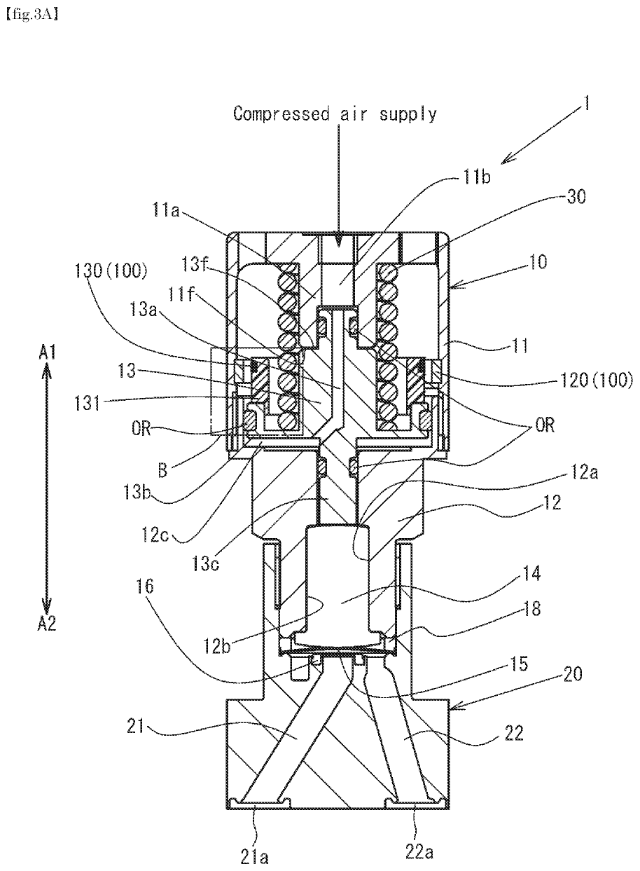

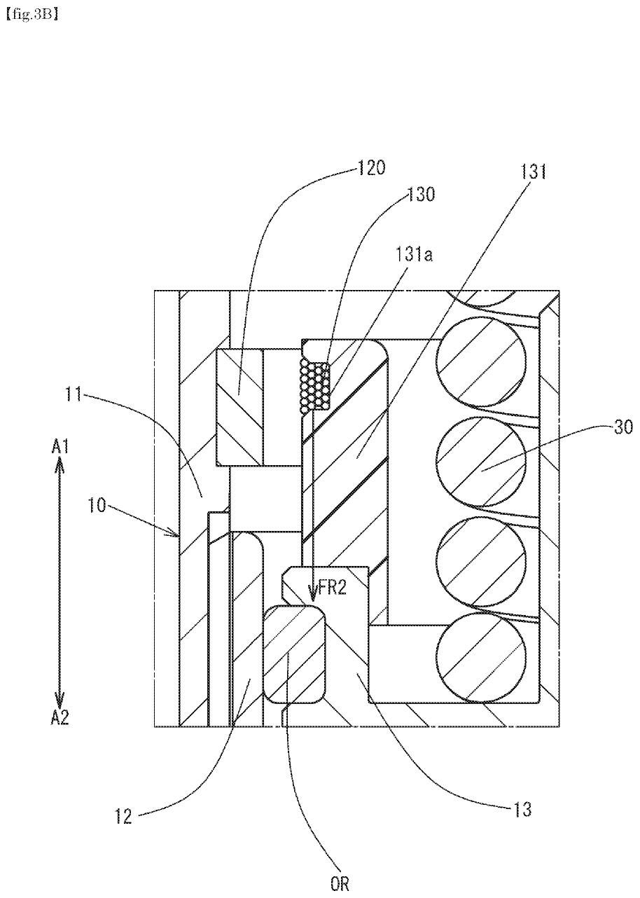

FIGS. 1 to 3B are drawings illustrating a configuration of a valve device according to an embodiment of the present invention. FIG. 1 is an external perspective view, FIG. 2A is a longitudinal sectional view in a closed state. FIG. 2B is an enlarged sectional view of a region surrounded by a chain line A in FIG. 2A, FIG. 3A is a longitudinal sectional view of the valve device in FIG. 1, in an opened suite, and FIG. 3B is an enlarged sectional view of a region surrounded by a chain line B in FIG. 3A. It should be noted that, in the drawings, arrows A1, A2 indicate upward and downward directions, A1 being the upward direction and A2 being the downward direction.

A valve device 1 includes a pipe connecting part 3, an actuator part 10, and a valve body 20. The pipe-connecting part 3 is connected to a piping (not illustrated), and supplies a compressed air as a driver gas to the actuator part 10 or discharges an air released from the actuator part 10 to the outside.

The actuator part 10 includes an actuator cap 11 having a cylindrical shape, an actuator body 12, a piston member 13, a diaphragm presser 14, and a power generation unit 100.

The actuator cap 11 includes a cylindrical pan 11a extending from a ceiling pan in the downward direction A2. An inner peripheral surface of the cylindrical part 11a defines a flow channel 11b for air, and the flow channel 11b communicates with the pipe connecting part 3.

The actuator body 12 includes a guide hole 12a that guides the diaphragm presser 14 in the upward and downward directions A1, A2 at a lower side thereof, and communicates to an upper side of the guide hole 12a to form a through hole 12b. On an upper side of the actuator body 12, a cylinder chamber 12c is formed, which slidably guides a piston part 13b of the piston member 13 in the upward and downward directions A1, A2 via an O-ring OR.

The piston member 13 includes a flow channel 13a communicating to the cylinder chamber 12c in a central portion. The flow channel 13a communicates with the pipe-connecting part 3. The piston part 13b and a tip end shaft part 13c of the piston member 13 freely moves through the cylinder chamber 13c and the through hole 12b in the upward and downward directions A1, A2 via the O-ring OR.

The diaphragm presser 14 is movable in the upward and downward directions A1, A2 by the guide hole 12a of the actuator body 12.

The valve body 20 has an upper side screwed wan a lower side of the actuator body 12, and defines flow paths 21,22 of a gas or the like that include openings 21a, 22a on bottom surfaces thereof. The flow paths 21, 22 are connected with other flow path members via a seal member (not illustrated).

A valve seal 16 is provided around the flow path 21 of the valve body 20. The valve seat 16 is formed from a resin such as perfluoroalkoxy alkane (PFA) or a polytetrafluoroethylene (PTFE) in an plastically deformable manner.

A diaphragm 15 functions as a valve clement, has a larger diameter than the valve seat 16, is formed in an elastically deformable manner into a spherical shell shape by a metal such as stainless steel or an NiCo-based alloy, or a fluorine-based resin. The diaphragm 15 is supported by the valve body 20 so as to allow contact with and separation from the valve seal 16 by being pressed toward the valve body 20 by a lower end surface of the actuator body 12 via a pressing adapter 18. In FIG. 2A, the diaphragm 15 is in a state of being pressed by the diaphragm presser 14, elastically deformed, and pressed against the valve seat 16. When the pressing by the diaphragm presser 14 is released, the diaphragm 15 is restored into a spherical shell shape. When the diaphragm 15 is pressed against the valve seat 16, the flow path 21 is closed, and when the diaphragm 15 is separated from the valve seat 16 as illustrated in FIG. 3A, the flow path 21 is released and communicates with the flow path 22.

A coil spring 30 is interposed between the ceiling pan of the actuator cap 11 and the piston part 13b of the piston member 13, and the piston member 13 is continually pressed by a restoring force in the downward direction A2. Accordingly, an upper end surface of the diaphragm presser 14 is pressed in the downward direction A2 by the piston member 13, and the diaphragm 15 is pressed toward the valve seal 16.

Here, the power generation unit 100 will be described.

The power generation unit 100 includes a permanent magnet 120 formed into a ring shape and fixed to an inner peripheral surface of the actuator cap 11, and a coil 130 wound and held around a holding groove 131a formed on an outer peripheral surface of a holding member 131 formed into a cylindrical shape and made of a resin. The piston member 13 and the holding member 131 can constitute a movable pan. The holding member 131 is disposed on an outer side of the coil spring 30 in a field of view from the movable direction, is held by the piston member 13, and can hold the coil 130. Accordingly, the coil 130 is disposed on the outer side of the coil spring 30 in a field of view from the movable direction. The actuator cap 11 serving as a fixed pan is in contact with the other end opposite to one end where the coil spring 30 is in contact with the piston member 13, and can hold the permanent magnet 120 on an outer side of the coil 130 in a field of view from the movable direction.

The permanent magnet 120 is magnetized in a radial direction. That is, the permanent magnet 120 is magnetized so that an inner peripheral side is an N-pole or an S-pole and an outer peripheral side is an S-pole or an N-pole.

The holding member 131 is fixed to the piston member 13 and moves together with the movement of the piston member 13 in the upward and downward directions. When the holding member 131 moves in the upward and downward directions, the coil 130 moves up and down relative to the permanent magnet 120. In response to an electrical load connected to the coil 130, an induced current flows through the coil 130 by electromagnetic induction, and power is supplied.

Here, the holding member 131 is made of an insulator such as a resin, for example, and thus suppresses unnecessary eddy current braking caused by reciprocation in a location where a strong magnetic field of the permanent magnet 120 is applied, and does not hinder the movement of the piston member 13. Further, a coil that can be mounted more lightly than a permanent magnet is fixed to the piston member 13 serving as a movable part, thereby minimizing an increase of the weight of the piston member 13. This minimizes the effect on the response speed of the valve.

The induced current flowing through the coil 130 changes according to the moving direction and speed of the coil 130, and acts on the permanent magnet 120 to generate a force in a direction that brakes the movement of the coil 130. As illustrated in FIG. 2B, when the coil 130 moves in the downward direction A2, an upward braking force FR1 against this acts on the piston member 13 via the holding member 131. As illustrated in FIG. 3B, when the coil 130 moves in the upward direction A1, a downward braking force FR2 against this acts on the piston member 13 via the holding member 131.

As illustrated in FIG. 2A, when the compressed air is released, the piston member 13 is pressed in the downward direction A2 by a restoring force of the coil spring 30, and the diaphragm presser 14 collides with the valve scat 16 via the diaphragm 15. The upward braking force FR1 described above acts so as to alleviate the impact at this time.

As illustrated in FIG. 3A, when the compressed air is supplied, the piston member 13 is pressed in the upward direction A1 against the elastic force of the coil spring 30, and a contact surface 13f of the piston member 13 collides with a contact surface 11f of the actuator cap 11. The downward braking force FR2 described above acts so as to alleviate the impact at this time.

As the moving speed of the coil 130 increases, a larger induced current is generated and a larger braking force is applied, and thus this braking force hardly generates a braking force when the piston member 13 starts to move. Thus, it is possible to alleviate the impact without adversely affecting the response speed compared 10 a case where the force acting on the piston member 13 is simply decreased by the driving pressure and the urging force of the coil spring 30 to slowly open and close the valve.

Further, as another mounting, a mounting is executed in which a braking force is added by power generation while increasing the pressure of the compressed air and me urging force of the coil spring 30, thereby making it possible suppress the impact on the diaphragm 15 to the same extent, and improve the response speed of the valve while maintaining the valve service life to the same extent.

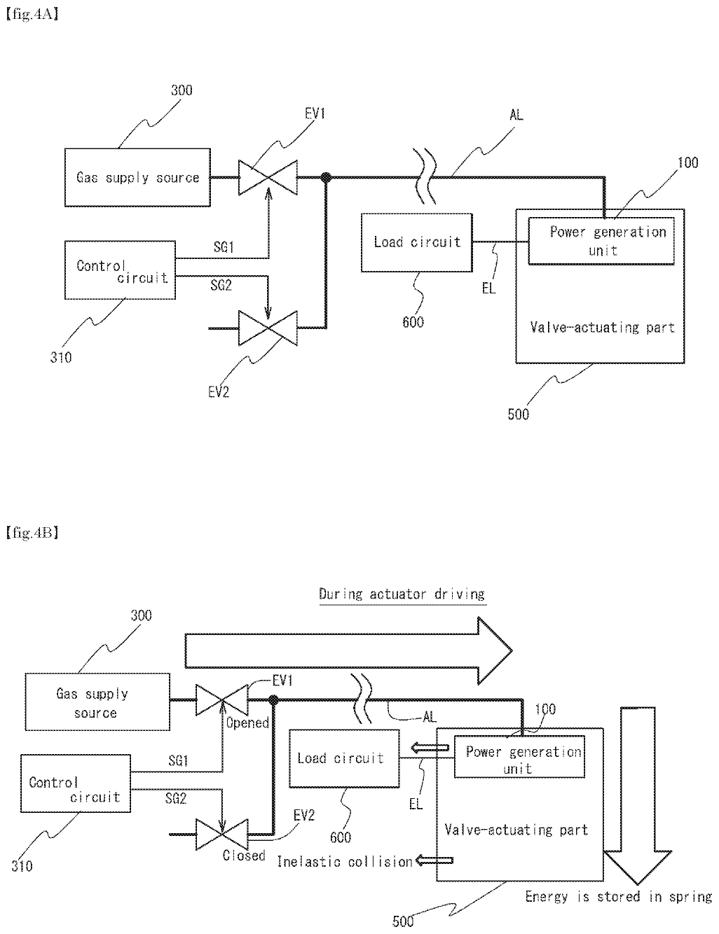

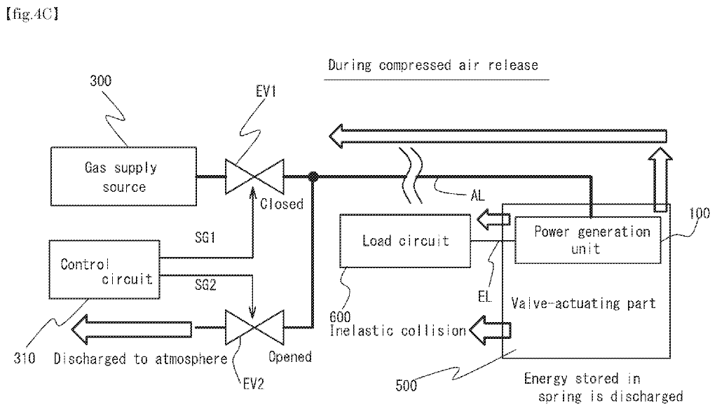

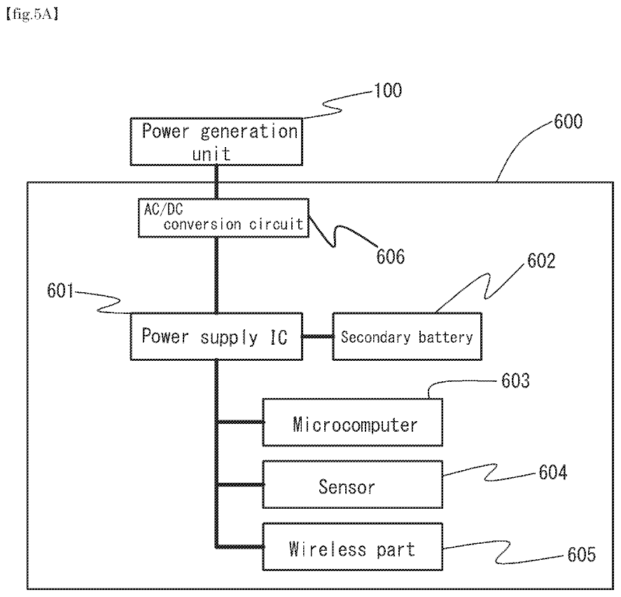

FIG. 4A illustrates an example of a system that activates the valve device 1 having the above-described configuration. In FIG. 4A, a valve-activating part 500 is a portion related to a flow of energy when the valve device 1 is activated, and refers to the actuator part 10 and the coil spring 30. A gas supply source 300 has a function of supplying a compressed air to the valve device 1 through an air line AL flu idly connected to the pipe connecting part 3 of the valve device 1, and is, for example, an accumulator or a gas cylinder. An electromagnetic valve EV1 is provided in the middle of the air line AL, and an electromagnetic valve EV2 is provided to the air line AL branched on a downstream side of the electromagnetic valve EV1. A control circuit 310 outputs control signals SG1, SG2 to the electromagnetic valves EV1, EV2 to control the opening and closing of the electromagnetic valves EV1, EV2.

A load circuit 600 is an electric circuit electrically connected to the coil 130 of the power (mention unit 100 as a load. The load circuit 600 is electrically connected to the power generation unit 100 via an electrical line EL.

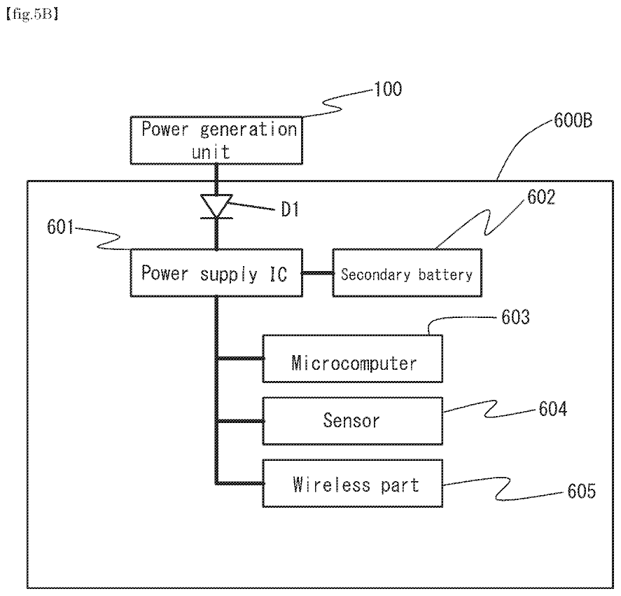

FIG. 5A illustrates an example of the load circuit 600. It should be noted that, in the drawings, a GND line is omitted.

The load circuit 600 includes a power supply integrated circuit (IC) 601, a secondary battery 602, a microcomputer 603, various sensors 604 such as a pressure sensor and a temperature sensor, a wireless communication pail 605 capable of transmitting data detected by the various sensors 604 to the outside, and an AC/DC conversion circuit 606.

The current generated in the coil 130 of the power generation unit 100 is reversed in polarity in accordance with the moving direction of the piston member 13, and thus is converted into a direct current by the AC/DC conversion circuit 606.

The power supply IC 601 functions as a power management IC that regulates power transmitted to a power supply destination such as the microcomputer 603, the various sensors 604, or the wireless communication part 605, while boosting and storing the power from the coil 130 in the secondary battery 602, for example, as the power supply IC 601, a power supply IC commonly available for energy harvesting can be adopted.

The secondary battery 602 stores direct current power supplied from the power supply IC 601. A capacitor having a relatively large capacity can also be used in place of the secondary battery.

Components other than the various sensors 604 are housed in a circuit housing part (not illustrated; provided on an upper surface of the actuator cap 11, for example), and the various sensors 604 are disposed near the flow path or the like of the valve device 1 to detect pressure and temperature, and are electrically connected by wiring with the power supply IC 601 and the microcomputer 603.

Next, the schematic How of the energy and the power generating operation of the power generation unit 100 of the system in FIG. 4A will be described with reference to FIGS. 4B and 4C.

When the valve is opened, the actuator pan 10 needs to be driven and thus, as illustrated in FIG. 4B, the electromagnetic valve EV1 is opened and the electromagnetic valve EV2 is closed. Accordingly, the driver gas is supplied from the gas supply source 300 to the valve device 1. Here, the driver gas refers to a gas having a pressure higher than atmospheric pressure and high enough to drive the valve device 1. In the present embodiment, compressed air is used as the driver gas.

The piston member 13 is pressed in the upward direction A1 by the supply of compressed air 10 the valve device 1, as illustrated in FIGS. 3A and 3B. At this time, the coil 130 of the power generation unit 100 moves in the upward direction A1, thereby supplying power to the load circuit 600. The supplied power is used to charge the secondary battery 602 while consumed by the various sensors 604 and the like.

The coil spring 30 is compressed and energy is stored in the coil spring 30. At this time, as illustrated in FIG. 3A, a contact surface 13f of the piston member 13 inelastically collides with a contact surface 11f of the actuator cap 11, and thus a portion of the energy supplied from the gas supply source 300 to the valve device 1 is convened to heat and vibration and discharged.

When the valve is closed, the compressed air stored in the valve device 1 is released, and the energy stored in the coil spring 30 is discharged. As illustrated in FIG. 4C, the electromagnetic valve EV1 is closed and the electromagnetic valve EV2 is opened. When the compressed air is discharged from the valve device 1 to live outside through the air line AL and the electromagnetic valve EV2, the coil 130 of the power generation unit 100 moves in the downward direction A2, thereby supplying power to the load circuit 600. The supplied power is used to charge the secondary battery 602 while consumed by the various sensors 604 and the like.

Because the secondary battery 602 is charged while the valve is used, long-term operation is possible using the secondary battery 602 having a small capacity compared to when a primary battery is used. The energy stored in the battery can be decreased, making it possible to increase safely.

According to the present embodiment, the power generation unit 100 provided lo the valve device 1 generates a force in an orientation that alleviates the impact associated with the opening and closing operation of the diaphragm 15, making it possible to alleviate the load on the valve clement of the diaphragm 15 and the like and prolong the service lite of the valve device 1 while solving the problems of power supply wiring or battery replacement.

Further, in the valve device 1 according to the present embodiment, a portion of the energy stored in the coil spring 30 is utilized to generate power, making it possible to effectively utilize a portion of the energy that is otherwise discharged as heat or vibration.

Furthermore, since an induced current is generated in the coil 130 only during the opening and closing operation of the valve device 1, it is also possible to monitor this and make use of this as u sensor for measuring the opening/closing frequency as well as the opening and closing speed of the valve device 1. By analyzing such data in addition to the data of the other various sensors 604, it is possible to improve the accuracy of fault determination and fault prediction.

In the above-described embodiment, a case is illustrated in which the power generation unit 100 generates power both when the actuator pan 10 is driving and when the compressed air is released.

FIG. 5B illustrates an example of a load circuit 600B applied to another embodiment of the present invention. A power generated only either when the actuator part 10 is driving or when compressed air is released is consumed by charging the battery through the power supply IC 601, or the like.

A diode D1 of the load circuit 600B is connected so as to supply the power generated by the coil 130 to the load circuit 600B only when the power is generated using a portion of the energy stored in the coil spring 30. Accordingly, it is possible to obtain a braking force by power generation when the valve is closed and the impact on the diaphragm 15 is large, while maintaining the response speed for opening the valve without generating a braking force caused by an induced current when the valve is opened. As a result, it is not necessary lo increase the pressure of the compressed air supplied for power generation, even under the condition of maintaining the response speed as a valve, making it possible to utilize the energy without waste. Further, the fact that the operation specifications such as the pressure of the compressed air to be supplied and the response speed of the valve do not substantially change is useful when replacing the valve device of the existing fluid control system.

It should be noted that a mounting in which power generated only during introduction of compressed air is supplied to the load circuit 600B is also possible by reversing the orientation of the diode D1.

While a so-called normally closed valve is given as an example in the above-described embodiment, the present invention is not necessarily limited thereto and can be applied to a so-called normally opened valve as well.

While a case where the valve device 1 is driven by compressed air is given as an example in the above-described embodiment, a gas other than air can also be used.

While a diaphragm-type valve is given as an example in the above-described embodiment, the present invention is not necessarily limited thereto and can be applied to other types of valves as well.

### DESCRIPTIONS OF REFERENCE NUMERALS

1 Valve device

3 Pipe-connecting part

10 Actuator part (Actuator)

11 Actuator cap (Fixed part)

12 Actuator body (Fixed part)

13 Piston member (Movable part)

14 Diaphragm presser

15 Diaphragm

16 Valve seat

18 Pressing adapter

20 Valve body (Fixed pan)

30 Coil spring (Spring member)

100 Power generation unit

120 Permanent magnet

130 Coil

131 Coil-holding member (Movable part)

300 Gas supply source

310 Control circuit

500 Valve-actuating part

600, 600B Load circuit

1. A valve device comprising:
a movable part that receives a supply of a driver gas and drives a valve element;
a fixed part that does not move regardless of activation of the movable part; and
a power generation unit including a coil provided to om of the movable part and a driving part, and a permanent magnet provided to the other of the movable pan and the driving part.

2. The valve device according to claim 1, wherein
the coil is provided to the movable part, and
the permanent magnet is provided lo the fixed part.

3. The valve device according to claim 1, further comprising:
a spring member that presses the movable part in one direction, wherein
the power generation unit generates a power using a portion of energy stored in the spring member.

4. The valve device according to claim 1, further comprising:
a circuit for extracting only a current in n direction of a power generated by the power generation unit when the driver gas supplied to the valve device is discharged outside.

5. The valve device according to claim 1, further comprising:
a power supply circuit that boosts a voltage of a power generated by the generator; and
a load activated by a power supplied from the power supply circuit.

6. The valve device according to claim 5, further comprising:
a secondary battery or a capacitor that receives a power supply from the power supply circuit.

7. The valve device according to claim 1, wherein
the power generation unit is provided so that a force is generated in an orientation that alleviates an impact associated with opening and closing operations of the valve element.

8. The valve device according to claim 3, wherein
the coil is disposed on an outer side of the spring member in a field of view from a movable direction.

9. The valve device according to claim 3, wherein
the movable part includes a piston member and a holding member that is disposed on an outer side of the spring member in a field of view from a movable direction, is held by the piston member, and holds the coil.

10. The valve device according to claim 3, wherein
the fixed part is in contact with the other end of the movable part opposite to one end where the spring member is in contact, and holds the permanent magnet on an outer side of the coil in a field of view from the movable direction.

11. The valve device according to claim 1, wherein
the permanent magnet is formed into a ring shape and magnetized in a radial direction.

12. The valve device according to claim 1, further comprising:
a pressure sensor or a temperature sensor activated by a power generated by the power generation unit.

13. The valve device according to claim 12, further comprising:
a wireless communication part that is activated by a power generated by the power generation unit, and transmits data detected by the pressure sensor or the temperature sensor in a wireless manner.
